(19) United States
(12) Patent Application Publication
(10) Pub. No.: US 2005/0040650 A1
(43) Pub. Date: Feb. 24, 2005

(54) Easy assembled tube connector

(76) Inventor: Tuan Hsu Chang, Taipei (TW)

Correspondence Address: Tuan Hsu Chang, 235 Chung-Ho, Box 8-24, Taipei, TW

(21) Appl. No.: 10/642,486

(22) Filed: Aug. 18, 2003

(51) Int. Cl. H01R 25/00

(52) U.S. Cl. 285/340; 285/319

(57) ABSTRACT

An easy assembled tube connector is disclosed. A buckling ring is embedded into a tube body and a connecting seat of a tube joint is engaged into the buckling ring. Then it is rotated through a predetermined angle so as to complete the assembly work. The tube joint with the connecting seat is made as a multi-directional joint so as to connect a plurality of tube bodies. Thus, the tube joint can be used to different lamp tubes, display tubes, electric tubes, wire tubes, etc., especially for the tubes with wires therein or high pressure tubes.

### FIELD OF THE INVENTION

The present invention relates to tube joints, and particularly to a easy assembled tube connector, wherein a buckling ring is embedded into a tube body and a connecting seat of a tube joint is engaged into the buckling ring. The tube joint with the connecting seat is made as a multi-directional joint so as to connect a plurality of tube bodies.

### BACKGROUND OF THE INVENTION

In the prior art, tubes, such as lamp tubes, display tubes, electric tubes, wire tubes, need tube joints for connecting different tubes so as to from pipelines. Thereby, electric wires, power wires, or gas tubes can pass through the tubes.

Currently, most of the tube joints are formed with outer threads and the tubes are threaded in the inner surface. The nuts used in the tube joints are hexagonal shapes. Thereby, the outer thread of the tube joint can be connected to the inner thread of the tube body.

However, the above mentioned prior art is not beneficial to be loaded with electric wires, cables, signal wires, or gas tubes. This is because in the screwing process, the wires or tubes in the tube body will rotate. Thus this will induce some problems in assembly.

### SUMMARY OF THE INVENTION

Accordingly, the primary object of the present invention is to provide an easy assembled tube connector, wherein the lines or wires in a tube can be arranged in order.

To achieve above object, the present invention provides an easy assembled tube connector, wherein a buckling ring is embedded into a tube body and a connecting seat of a tube joint is engaged into the buckling ring. Then it is rotated through a predetermined angle so as to complete the assembly work. The tube joint with the connecting seat is made as a multi-directional joint so as to connect a plurality of tube bodies. Thus, the tube joint can be used to different lamp tubes, display tubes, electric tubes, wire tubes, etc., especially for the tubes with wires therein or high pressure tubes.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a cross sectional view showing that

FIG. 2(A) is a cross sectional view along the line A-A of FIG. 2.

FIG. 2(B) is a cross sectional view along line B-B of FIG. 2.

FIG. 2(C) is a cross sectional view along line C-C of FIG. 2.

FIG. 3 is a cross sectional view showing that the connecting seat is embedded into the buckling ring according to the present invention.

FIG. 3(D) is a cross sectional view along line D-D of FIG. 3.

FIG. 3(E) is a cross sectional view along line E-E of FIG. 3.

FIG. 3(F) is a cross sectional view along line F-F of FIG. 3(D).

FIG. 4 is a cross sectional view showing that the tube body is rotated to a buckling angle according to the present invention.

FIG. 5(G) is a cross sectional view showing FIG. 4 of the present invention.

FIG. 6(H) is a cross sectional view of the line H-H of FIG. 5.

FIG. 7 is an exploded perspective view showing the applications of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

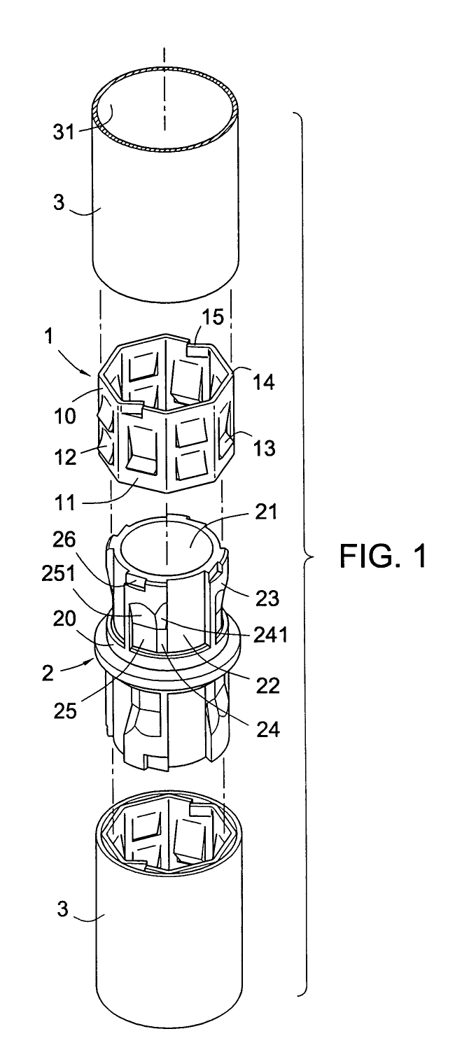

Referring to FIG. 1, the easily assembled tubular connector of the present invention is illustrated. The easily assembled tubular connector includes a plurality of buckling rings 1 and a tube joint 2.

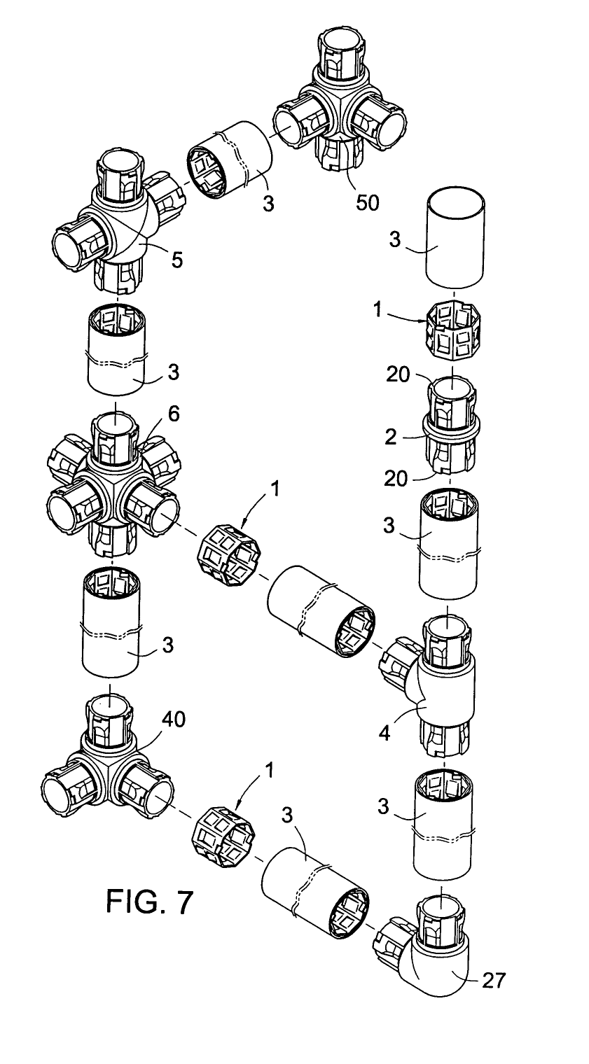

Each buckling ring 1 has a polygonal shape. In the embodiment of the present invention shown in FIGS. 1 to 7, the buckling rings 1 have eight end surfaces 10, 11. The end surfaces 10 and end surfaces 11 are alternatively arranged. Each end surface 10 is formed with at least one outward extended elastic claw 12. The end surfaces having the claws 12 are not adjacent to one another. Each end surface 11 is formed with at least one elastic hook 13. Each hook 13 has an “ [symbol] ” (which is pronounced as “ai”, a Chinese word) shape. Two opposite end surfaces 11 in the buckling ring 1 is formed with inwards inclined stop 15.

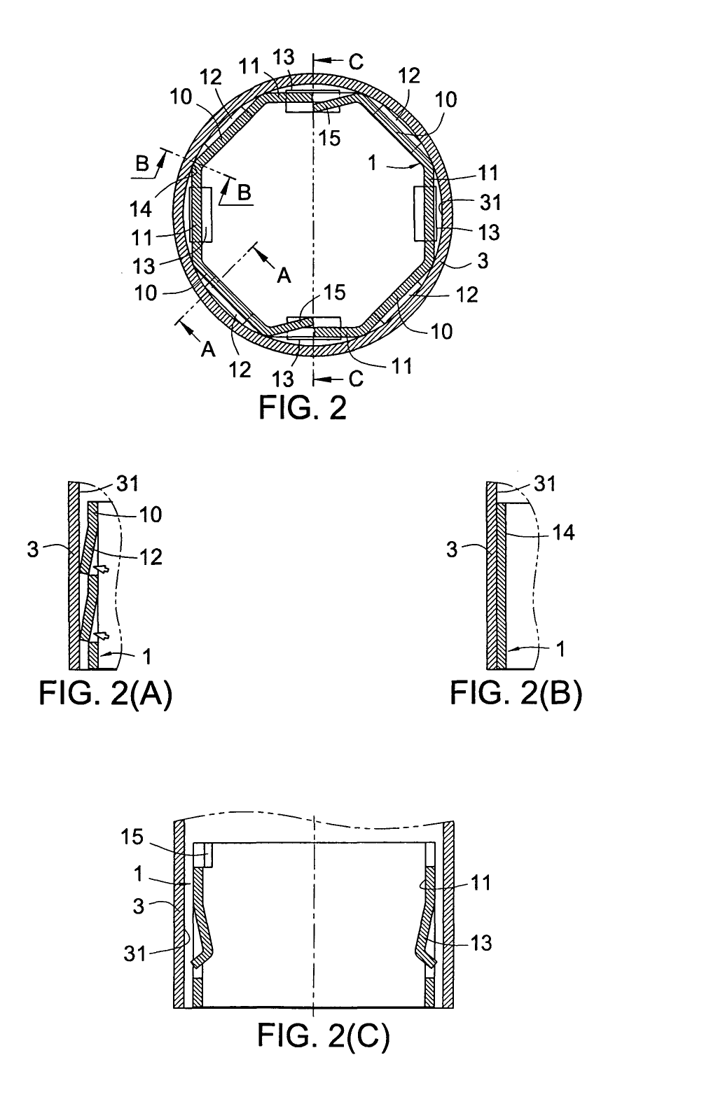

The buckling ring 1 must be embedded into the wall 31 of the tube body 3 (referring to FIG. 2). The plurality of elastic claws 12 on the buckling ring 1 can be compressed to be embedded into a tube for positioning. The claws 12 positioning within a tube will buckle the wall 31 by the lower outward elastic sheet (referring to FIG. 2A). Thereby, the buckling ring 1 will not fall but from the tube body 3. Moreover, other then the plurality of elastic claws 12, the part of the buckling ring 1 buckled to the wall 31 includes the end walls 14 of the buckling ring 1 (referring to FIG. 2B). Thus, the buckling ring 1 can be steadily buckled within the wall 31 of the tube body 3. Further, the “ [symbol] ” shape hooks 13 on the buckling ring 1 will be inward reduced to be stand in the tube body 3 (referring to FIG. 2(C)).

In FIGS. 1 to 6 of the present invention, the tube joint 2 has a tube joint 2 which can be buckled at two ends.

The tube joint 2 has an approximate round shape connecting seat 20. Each connecting seat 20 has a through hole 21. The connecting seat 20 has a shape corresponding that of the buckling ring 1. Thereby, in this embodiment, the connecting seat 20 has an octagonal shape, and has corresponding grooves 22 and stoppers 23 (referring to FIG. 1). The stoppers 23 and the grooves 22 are alternatively arranged so as to form an octagon. Each stopper 23 is at the edge of the through hole 21. One side of each stopper 23 far away from the edge of the through hole 21 is connected to a first stepped surface 24 and a second stepped surface 25. The tops of the first stepped surface 24 and second stepped surface 25 are installed with a first inclined surface 241 and the second inclined surface 251 which are connected to the stopper 23. A top of each stopper 23 is formed With a recess 26.

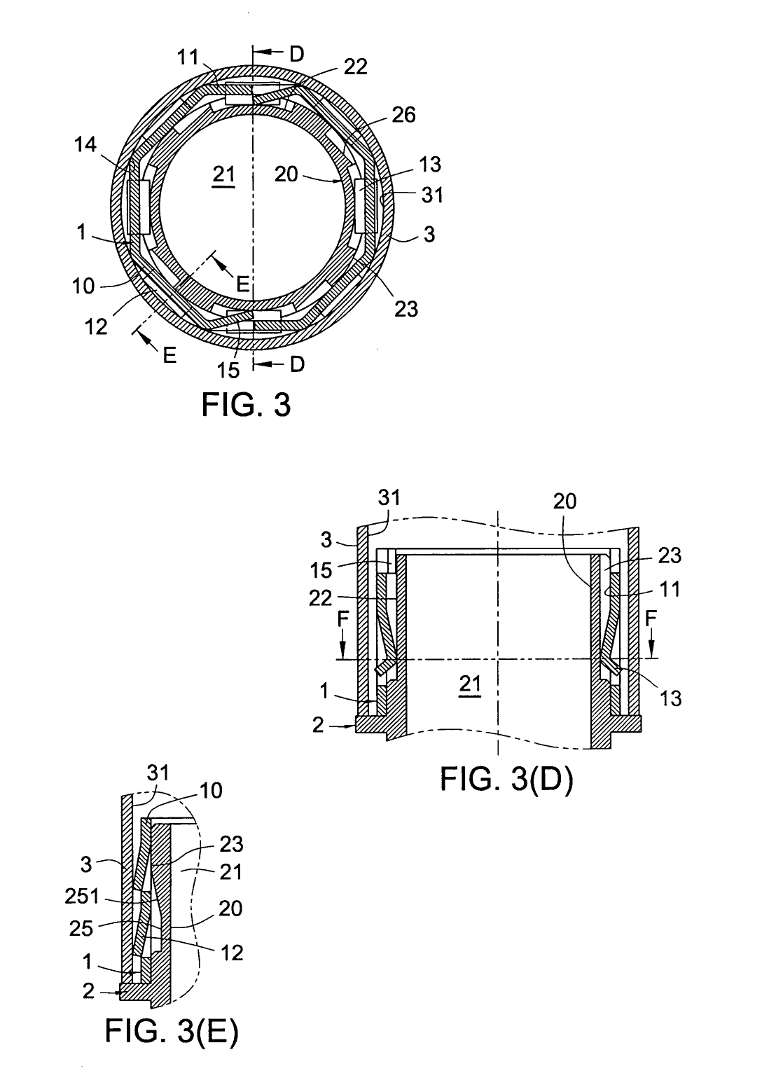

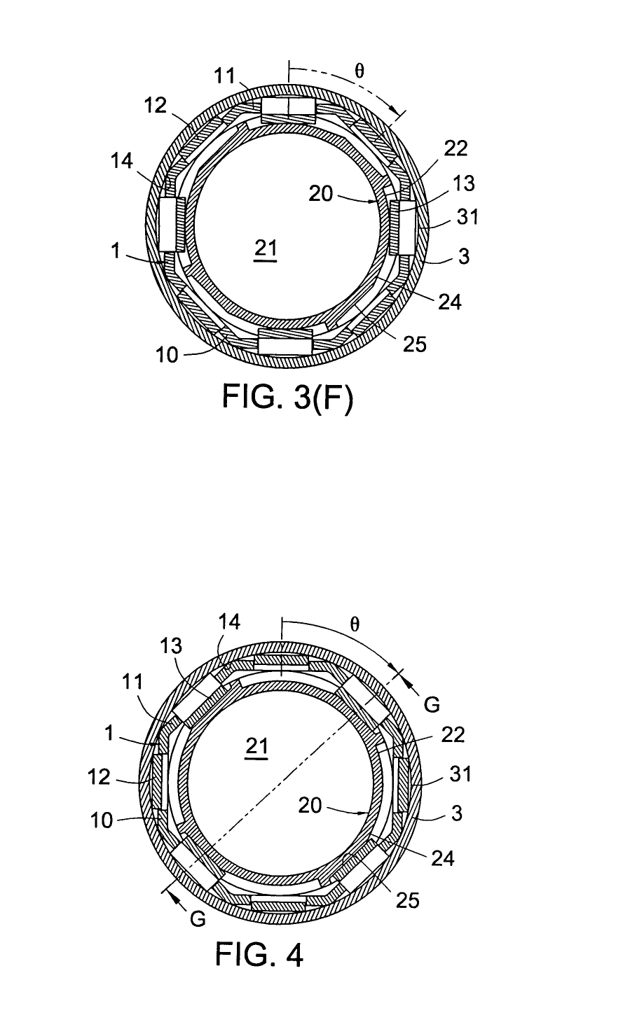

Each connecting seat 20 of the tube joint 2 can be embedded into the buckling ring 1 firstly (referring to FIG. 3). In embedding process, each groove 22 of the connecting seat 20 is coupled with a respective hook 13. The inclined stop 15 at one the end surface 11 of the buckling ring 1 can be temporarily coupled to the groove 22 (referring to FIGS. 3(D) and 3(F)). Meanwhile, the claws 12 are expanded to be embedded into the wall 31 of the tube body 3. Thus, each end surface 10 has a sufficient space for embedding a respective stopper 23 (referring to FIGS. 3(E) and 3(F)).

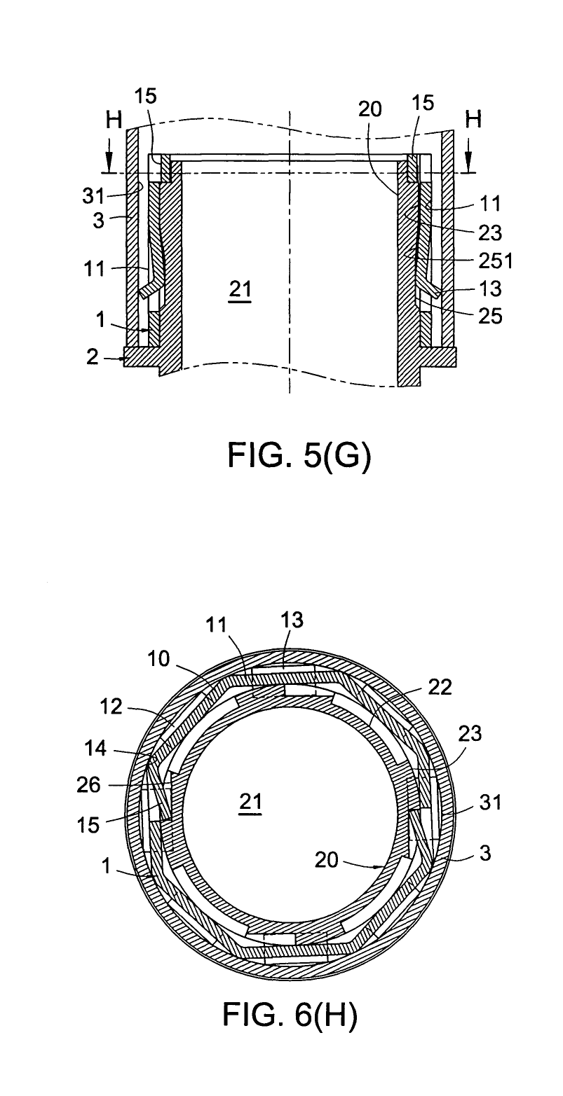

When the connecting seat 20 is embedded into the buckling ring 1 (referring to FIG. 3(F)), the tube body 3 and the buckled buckling ring 1 must be rotated or one of the connecting seat 20 and the tube joint 2 are rotated to a buckling angle θ (referring to FIG. 4) so that the hook 13 in the groove 22 can pass through the first stepped surface 24 to be elastically embedded into the second stepped surface 25. Thereby, the tube body 3 is engaged to the wall 31 (referring to FIG. 5(G)). Then the inclined stop 15 in the end surface 11 of the buckling ring 1 will buckle the recess 26 of the stopper 23 of the connecting seat 20 (referring to FIG. 6(H)). Thus, the tube joint 2 can be rapidly and firmly secured to the tube body 3.

When it is desired to detach the tube joint 2 from the tube body 3, it is only necessary to reversely rotate the tube joint 2 or the tube body 3 to above buckling angle 0. Then the tube body 3 can be draw out from the connecting seat 20. Thus the detaching work can be performed rapidly and easily.

In above embodiment, the end surfaces 10, 11 of the buckling ring 1, the grooves 22 and the stoppers 23 of the connecting seat 20 of the tube joint 2 have octagonal shapes. Each plane of the octagon is 45 degrees. Thus the buckle angle θ can not be over 45 degrees. Thus, the assembly work can be performed easily and conveniently. Otherwise the present invention can improve the connecting effect and the buckling ring 1 and connecting seat 20 can be connected firmly. In the present invention, the buckling ring 1 and the connecting seat 20 can be any polygonal shape. All these are within the scope of the present invention. Furthermore, in the present invention, the tube joint 2 with the connecting seat 20 is made as a multi-directional joint, such as the L shape two directional tube joint 27, the T shape three directional tube joint 4, the L shape three directional tube joint 40, the cruciform four directional tube joint 4, the curved cruciforni tube joint 50, the six directional tube joint 5, etc. so as to connect a plurality of tube bodies. Thus, the tube joint can be used to different lamp tubes, display tubes, electric tubes, wire tubes, etc., especially for the tubes with wires therein or high pressure tubes.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An easily assembled tubular connector comprising a plurality of buckling rings and a tube joint; each buckling ring being embedded into and buckled in an inner wall of a tube body; the tube joint being a multi-directional tube joint, i.e., the tube joint being connected to a plurality of tubes in different directions; each connecting direction being embedded with a respective connecting seat to be bucked with the inner wall and the buckling ring;
wherein each buckling ring is a polygon; one of two adjacent surfaces has formed with at least one protruded elastic claw which can be buckled to an inner wall of the tube body; the other of the two adjacent surface is formed with at least one inward reduced elastic hook which is reduced arranged in the tube body;
wherein the shape of each connecting seat of each tube joint is corresponding that of the buckling ring; each connecting seat is formed with grooves and stoppers coupled to the claws and hooks of the buckling ring, respectively;
wherein a lower end of each stopper is connecting to a first stepped surface and a second stepped surface; the first stepped surface is inclined with a higher side thereof to be connected to the first stepped surface; and the second stepped surface is inclined with a lower side thereof being connected to a respective one of the grooves;
wherein each groove is capable of being engaged with the hooks; when the tube body buckled with the buckling ring or the connecting seat of the tube body is rotated to a buckling angle, then the hook in the groove will pass through the first stepped surface to be elastically buckled to the second stepped surface and the inner wall of the tube body; thus the tube joint can be rapidly and firmly secured to the tube body.

2. The easy assembled tube connector as claimed in claim 1, wherein the claws are inclined sheets.

3. The easy assembled tube connector as claimed in claim 1, wherein each hook 13 has an “ [symbol] ” (pronounced as “ai”) shape.

4. The easy assembled tube connector as claimed in claim 1, wherein one of two adjacent surfaces has formed with at least one protruded elastic claw which can be buckled to an inner wall of the tube body; the other of the two adjacent surface is formed with at least one inward reduced elastic hook which is reduced arranged in the tube body.

5. The easy assembled tube connector as claimed in claim 1, wherein two opposite end surfaces in the buckling ring are formed with inwards inclined stop; and a top of each stopper is formed with a recess capable of buckling the inwards inclined stop.

6. The easy assembled tube connector as claimed in claim 1, wherein each connecting seat has a through hole.

7. The easy assembled tube connector as claimed in claim 1, wherein the tops of the first stepped surface and second stepped surface are installed with a first inclined surface and a second stepped surface, respectively, which are connected to the stopper.

8. The easy assembled tube connector as claimed in claim 1, wherein the bucking angle is equal to the angle of each face of the polygon of the buckling ring.

9. The easy assembled tube connector as claimed in claim 1, wherein the buckling angle is equal to the angle between the adjacent groove and stopper of the connecting seat.
